(19) United States
(12) Patent Application Publication
(10) Pub. No.: US 2026/0074525 A1
(43) Pub. Date: Mar. 12, 2026

(54) INTEGRATED COMBINED CYCLE AND RENEWABLE ELECTRICAL POWER GENERATION SYSTEM

(71) Applicant: Florida Power & Light Company, Juno Beach, FL (US)

(72) Inventors: Tobias NEITZEL, Palm City, FL (US); Fabian A. CAMACHO, Jupiter, FL (US); Chad M. GARNER, Jupiter, FL (US); Christian M. HANSEN, Palm Beach Gardens, FL (US)

(21) Appl. No.: 18/830,773

(22) Filed: Sep. 11, 2024

(51) Int. Cl. H02J 3/40; F01K 15/00; H02J 3/38

(52) U.S. Cl. CPC H02J 3/40; F01K 15/00; H02J 3/381; H02J 2101/22; H02J 2101/28; H02J 2101/40

(57) ABSTRACT

Systems and methods for operating an integrated electrical power plant. A site power output setpoint is received for an electrical power interconnection point that receives power from a combined cycle electrical power generation plant and a renewable energy electrical power generation plant. A thermal energy storage system provides heat to generate steam to drive a steam turbine of the combined cycle electrical generation plant. An indication of a total electrical output delivered to the electrical power interconnection point is received. Based on a difference between the indication and the setpoint, an adjustment is made to at least one of: steam generated by heat delivered from the thermal energy storage system; or electrical energy delivered by the renewable energy electrical power generation plant to generate thermal energy in the thermal energy storage system.

### FIELD OF THE DISCLOSURE

The present disclosure generally relates to electrical power generation systems, and more particularly to renewable energy electrical power generation resources integrated with fossil fuel electrical power generating plants.

### BACKGROUND

Renewable energy sources are being deployed to play a progressively larger role in electrical power generation. In some instances, the installation of significant renewable energy based electrical power generation can lead to the reduction in the requirement for existing, generally fossil fueled powered, electrical power generation plants.

### BRIEF DESCRIPTION OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present disclosure, in which:

FIG. 1 illustrates an integrated electrical power site schematic, according to an example;

FIG. 2 depicts a controller and program storage, according to an example;

FIG. 3 illustrates a combined cycle plant retrofitting diagram, according to an example;

FIG. 4 illustrates an integrated electrical power plant operating process, according to an example;

FIG. 5 illustrates a heat recovery steam generator preheating process, according to an example;

FIG. 6 illustrates a combined cycle electrical power generation plant retrofitting process, according to an example; and

FIG. 7 illustrates a block diagram illustrating a processor, according to an example.

### DETAILED DESCRIPTION

As required, detailed embodiments are disclosed herein; however, it is to be understood that the disclosed embodiments are merely examples and that the systems and methods described below can be embodied in various forms. Therefore, specific structural and functional details disclosed herein are not to be interpreted as limiting, but merely as a basis for the claims and as a representative basis for teaching one skilled in the art to variously employ the disclosed subject matter in virtually any appropriately detailed structure and function. Further, the terms and phrases used herein are not intended to be limiting, but rather, to provide an understandable description.

The terms “a” or “an”, as used herein, are defined as one or more than one. The term plurality, as used herein, is defined as two or more than two. The term “another,” as used herein, is defined as at least a second or more. The terms “including” and “having,” as used herein, are defined as comprising (i.e., open language). The term “coupled,” as used herein, is defined as “connected,” although not necessarily directly, and not necessarily mechanically. The term “configured to” describes hardware, software or a combination of hardware and software that is adapted to, set up, arranged, built, composed, constructed, designed or that has any combination of these characteristics to carry out a given function. The term “adapted to” describes hardware, software or a combination of hardware and software that is capable of, able to accommodate, to make, or that is suitable to carry out a given function.

The below described systems and methods address several challenges to electrical power grid operations that may accompany an increase in the deployment of renewable energy based electrical power generation capacity. The deployment of renewable energy based electrical power generation capacity may drive the decommissioning of some existing, generally fossil fueled powered, electrical power generation plants due to their generation capacity being replaced by, for example, an increase in solar and wind energy based electrical power generation capacities. Decommissioning of such existing power plants may lead to challenges in maintaining grid stability during periods of high renewable energy based electrical power generation. Further challenges may develop due to the inconsistent nature of some renewable energy sources. Solar energy, for instance, does have an intermittent nature that is dependent on sunlight availability.

Another challenge may be an inability to effectively utilize excess electrical power that is generated by renewable energy during periods where there are high levels of renewable energy availability and system wide demand may be less than that supply. Photovoltaic solar farms, for example, generate high power levels during the day when sunlight is generally its strongest. Demand during such times of high-level power generation may be below the amount of power generated by such renewable resources, and, in some instances, such available power may not be utilized but rather such generation resources are operated with curtailment of the renewable electrical generation capacity. Effective utilization of such excess electrical power may be achieved by harnessing and storing this surplus power so that it can later be deployed during periods of high demand or low renewable energy based electrical power generation. With some conventional systems, periods of reduced renewable energy, such as solar or wind, and the consequential reduction in renewable energy based electrical power generation are handled by, for example, operating “peaker” plants, which are electrical power generation plants designed for relatively short operations to fill short term shortfalls in electrical power generation due to various factors. The need for operation, and possible installations, of such peaker plants is able to be reduced by the above described harnessing and storage of excess electrical power generated from renewable energy sources.

The below described systems and methods in an example provide a process to integrate renewable electrical power generation with a combined cycle electrical power generation plant. The below described systems and methods in various examples are able to be applied to new power plant construction or as part of projects to repurpose existing power plant infrastructure in a cost-effective, sustainable, and efficient manner that accommodates the transition towards renewable-dominated power generation. In an example, repurposing an existing combined cycle electrical power generation plant adds thermal energy storage and provides modifications to allow the operation of the existing generators in that combined cycle electrical power generation plant as synchronized condensers. In some examples, such installations are able to have modes that allow such installation to also operate as a fossil fueled combined cycle electrical power generation plant in order to generate power when conditions warrant such operations. In some examples, the combined cycle electrical power generation plant is able to serve a function as a peaker plant when insufficient renewable energy or stored energy is available. Such deployments in some examples address issues such as grid stability, optimal utilization of renewable power, efficient power management in peaker plant operations and investment, and innovative use of existing infrastructure.

The below described systems and methods provide a streamlined and integrated solution for harnessing renewable energy, enhancing grid stability, and, in some examples, maximizing the reuse of existing power plant infrastructure. The below described systems and methods in an example allow the integration of multiple energy sources, including renewable energy sources, into a site that is able to produce electrical power with reduced variations over time. In some examples, a smart machine learning based controller is included that is trained to adjust the capabilities and operations of every component in the system and allows for the intelligent and automatic optimization of energy generation, conservation and utilization based on grid demand. The operations of such a controller in an example allow a smooth operating transition between producing electrical power by only renewable sources by controlling the starting, increasing, reducing, halting, or any combination of these, of the production of electrical power from fossil fuels based on various operating scenarios given electrical demand and levels of available renewable energy.

In an example, a conventional combined cycle electrical power generation plant included in the below described systems and methods has a fossil fueled combustion turbine that produces a hot exhaust stream. This hot exhaust stream is provided in an example to a heat exchanger to create super-heated steam to drive a steam turbine. The combustion turbine and the steam turbine each drive its own associated electrical generator to produce electrical power. In an example, these two electrical generators both are connected to a power interconnection point to provide electrical power to a power distribution or transmission system. The below systems and methods in an example provide a comprehensive approach that can be used to transform an existing combined cycle electrical power generation plant into an efficient “clean energy center” that is able to provide improved grid stability, optimal utilization of renewable energy, and efficient power management.

The below described systems and methods also integrate thermal energy storage into the combined cycle and renewable energy electrical power generation system. In an example, electrical power generated by a photovoltaic solar farm is able to be used to generate heat that is stored in the thermal energy storage system. In such an example, surplus solar power is harnessed and converted into thermal energy during peak daylight hours when solar generation is at its highest.

In various examples, heat extracted from a thermal battery storage system is exchanged with other systems via a high temperature fluid (HTF) heat exchange circuit. The heat from the thermal battery storage system in an example generates steam of various temperatures, including superheated steam at very elevated temperatures. Such generated steam is able to be utilized for various purposes such as pre-warming a combustion turbine to support rapid startup of the combustion turbine, pre-warming or maintaining heat in combined cycle components, providing auxiliary steam to Balance of Plant (BoP) machinery to support functions such as vacuum maintenance in the steam turbine condensers, other purposes, or combinations of these.

In some examples, one or both of the generators that are driven by the combustion turbine or the steam turbine are able to be configured to operate as a synchronous condenser. Operating a generator as a synchronous condenser in some examples is implemented by allowing the generator to be mechanically disconnected or otherwise released from the shaft of the turbine so as to spin freely. In further examples, the generator is able to remain connected to the shaft of the turbine and rotate the rotor of that turbine to which it is connected while operating as a synchronous condenser in order to provide more inertia. Operation of a generator as a synchronous condenser allows improved support of grid stability, such as during periods of high solar power influx, by compensating for reactive power on the grid. In some examples, the turbines in the combined cycle electrical power generation plants are equipped with clutches on the shaft driving its associated generator to allow the generators to spin freely and operate as synchronous condensers. In some examples, a generator operating as a synchronous condenser is able to remain mechanically coupled to its turbine shaft and the synchronous condenser operates while driving the rotor of the unfired combustion turbine or undriven steam turbine. In some arrangements, the turbine connected to a generator that is operating as a synchronous generator is able to be started in order to drive the generator's shaft and smoothly transition from operating as a synchronous condenser to generating electrical power as may be desired given electrical power demand.

In some examples, a generator normally driven by a steam turbine that is running as a synchronous condenser is able to be transitioned to an electrical power producing generator by starting the production of steam for the steam turbine through the use of stored thermal energy in a thermal energy storage system. When a generator is connected to the rotor of a steam turbine and that generator is operating as a synchronous condenser, it is spinning at the proper rotational speed and operating in phase synchronization with the grid. In some scenarios, starting the production of steam for the steam turbine while its generator is operating as a synchronous condenser facilitates the efficient and seamless transition from that generator operating as a synchronous condenser to producing electrical power. Such a transition is able to be more efficient than powering up one or both of the combustion turbine and steam turbine combination from a stopped condition as is conventionally performed in the operations of a conventional combined cycle electrical generation system.

The below described systems and methods facilitate improvements in grid stability and efficient renewable energy utilization. The dual-mode operation of the steam turbines, as either operating from excess heat from the combustion turbines or from heat provided by the thermal energy storage systems, enhances overall system flexibility and grid stability. The storage of excess solar power as thermal energy allows the efficient utilization of excess solar power that is generated during peak daylight hours when the demand for power may be lower. In some scenarios, the system supports a quick transition between generating steam for the steam turbines from excess heat generated by the combustion turbines and generating steam from stored thermal energy in order to support a smooth transition between solar power and other modes of energy production so as to minimize wasting energy.

In an example, the below described systems and methods are realized by retrofitting an existing combined cycle electrical power generation plant with a renewable energy electrical power generation plant, such as a photovoltaic solar farm, wind turbine farm, other generator, or combinations of these, and thermal storage equipment. In an example, at least one of the combustion turbine, the steam turbine, or both, of the combined cycle electrical power generation plant is retrofitted with a selective mechanical disconnect mechanism, such as any type of clutch or selective disconnect device. An example of a selective mechanical disconnect mechanism is an automatic overrunning clutch as is available from SSS clutch company of New Castle, Delaware, USA. Such retrofitting is able to utilize already existing infrastructure including not only generation equipment but electrical grid interconnection facilities to electrical power transmission or distribution facilities. Retrofitting an existing electrical power generation plant further minimizes costs and environmental impacts associated with new construction. In some examples, the thermal energy storage systems have a modular design that allows for scalability based on site-specific capacity and demand.

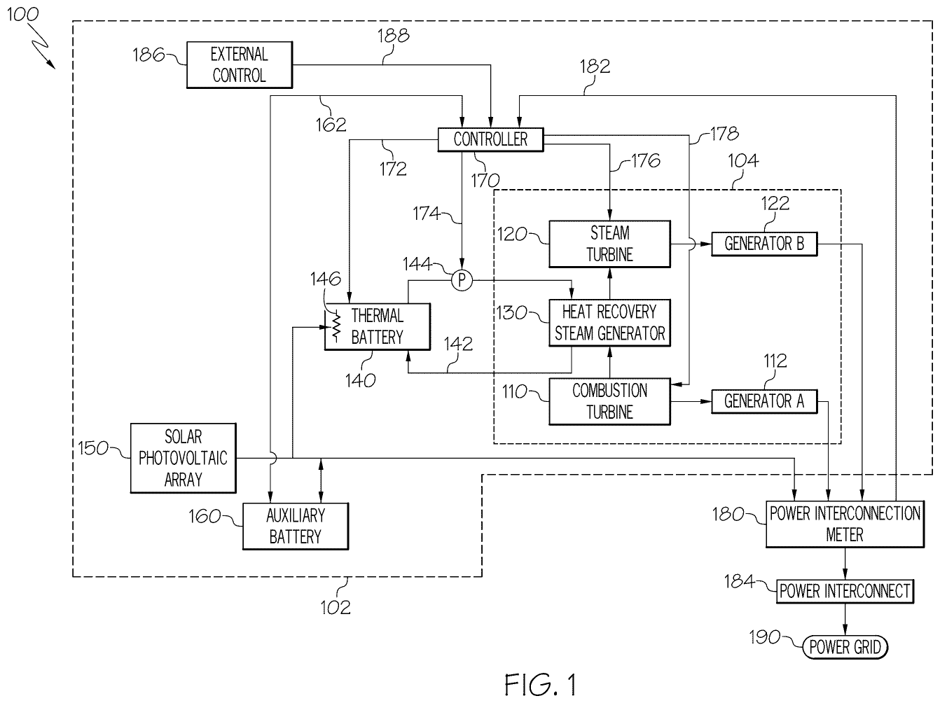

FIG. 1 illustrates an integrated electrical power site schematic 100, according to an example. The integrated electrical power site schematic 100 depicts an example configuration of components in an integrated electrical power plant. The integrated electrical power site schematic 100 depicts an integrated electrical power generation site 102 that has several electrical generation subsystems including a combined cycle electrical power generation plant 104, a solar photovoltaic array 150, and an auxiliary battery 160. The integrated electrical power site schematic 100 further includes a thermal battery 140, which has a resistive heater 146. The integrated electrical power site schematic 100 also has a controller 170, a power interconnection meter 180, and a power interconnection point 184 that connects the electrical generation subsystems of the integrated electrical power generation site 102 to a power grid 190.

In an example, the combined cycle electrical power generation plant 104 is a combined cycle natural gas fired power plant. In one example, the combined cycle electrical power generation plant 104 is an existing system that is being retrofitted to include thermal energy storage in the form of the thermal battery 140 and a renewable energy electrical power generation plant, such as the solar photovoltaic array 150. The retrofitted elements allow excess electrical energy produced by the renewable electrical generation source to be stored in the thermal battery 140 such that the stored energy is able to produce steam to drive a steam turbine 120 in the combined cycle electrical power generation plant 104. In an example, retrofitting an existing combined cycle electrical power generation plant 104 advantageously allows reuse of elements of that combined cycle electrical power generation plant 104 and also the connections to electrical distribution or electrical transmission infrastructure connections that are available at that site.

The combustion turbine 110 of the combined cycle electrical power generation plant 104 operates on a dual energy generation principle. The combustion turbine 110 operates to turn a turbine based on the combustion of a fossil fuel, such as natural gas, to provide power to turn its associated generator, generator A 112. In addition to providing power to generator A 112, waste heat from the combustion turbine 110 is harnessed by a heat recovery steam generator 130 to produce steam to drive a steam turbine 120 to turn its associated generator, generator B 122 to augment the total electricity output of the site.

A heat recovery steam generator 130 is an example of a heat exchanger that receives the exhaust from the combustion turbine 110 and uses the otherwise wasted heat in that exhaust to produce steam to turning the steam turbine 120. The steam turbine 120 receives steam from the heat recovery steam generator 130 and provides power to turn generator B 122 to further generate electricity. In an example, both generator A 112 and generator B 122 provide electrical power to the power interconnection meter 180 and the power interconnection point 184 for delivery to various consumers of that electrical power such as the power grid 190.

The solar photovoltaic array 150 harnesses solar energy to produce electrical power via the photovoltaic effect. This electrical power is provided to the power interconnection meter 180 and the power interconnection point 184 for delivery to various consumers of that electrical power such as the power grid 190. In an example, a selective amount of electrical power produced by the solar photovoltaic array 150 is also able to be provided to the resistive heater 146 to produce heat to charge the thermal battery 140 as is described below.

The thermal battery 140 in an example is designed to receive and store surplus energy produced by the solar photovoltaic array 150 during times of high solar energy availability such as during daylight hours, during times of lower demand, at other times when the solar photovoltaic array 150 is generating electrical power in excess of demand, or any combinations of these. As such, the thermal battery 140 is an example of a thermal energy storage system that is configured to store energy received in electrical power as thermal energy in thermal energy storage material contained within the thermal battery 140. One example of the use of the excess energy that is stored in the thermal battery is to reduce electrical power output fluctuations by being used to produce steam to drive the steam turbine 120, and thus generator B 122, during periods when electrical power demand is high, when the production by the solar photovoltaic array 150 is low, or both. The use of the stored thermal energy in this example is able to compensate for reductions in electrical power output of the solar photovoltaic array 150 as is able to be caused by, for example, a reduction in sunlight availability over the day or upon nightfall. In further examples, energy stored in the thermal battery 140 is able to be used for other purposes, as are described below.

In the illustrated example, the integrated electrical power generation site 102 is configured to have the thermal battery 140 provide stored heat energy to the heat recovery steam generator 130, which is an example of a heat exchanger, via a heat transfer fluid circuit 142. In further examples, the thermal battery 140 is able to provide heat to a separate heat exchanger to create steam to drive the steam turbine 120, as is further discussed below. A high temperature heat transfer fluid in an example is circulated through the heat transfer fluid circuit 142 by a heat transfer fluid pump 144. When driven by the heat transfer fluid pump 144, the heat transfer fluid flows into the thermal battery 140 system to absorb heat and then flows into the heat recovery steam generator 130 allowing the heat transfer fluid to exchange heat between thermal energy storage material in the thermal battery 140 and the heat recovery steam generator 130. Such heat exchanges cause steam to be generated in the heat recovery steam generator 130 by the thermal energy contained in the heat transfer fluid. In some examples, the amount of heat transferred from the thermal battery 140 to the heat recovery steam generator 130 is able to be varied by adjusting the speed of the heat transfer fluid pump 144 and thus the flow rate of the heat transfer fluid flowing between the thermal battery 140 and the heat recovery steam generator 130. In some examples, a resistive heater 146 is also or alternatively located within the heat transfer fluid circuit 142 to provide heat to the heat transfer fluid that is then delivered to the thermal battery 140 for storage.

In some examples, the thermal battery 140 stores energy by using one or more of various storage mediums or thermal energy storage materials such as carbon-graphite bricks, molten salt, cement, stone, ceramics, or combinations of these. In various examples, the thermal energy storage materials are able to be heated to temperatures based on their characteristics. In some examples, carbon or ceramic thermal energy storage materials are able to be heated up to about two thousand (2,000) degrees Fahrenheit (2,000° F.) or higher. In other examples, the thermal energy storage materials are able to be heated to temperatures based on various considerations such as the physical characteristics of the thermal energy storage materials, temperatures to be achieved by various other components of the system, other considerations, or combinations of these.

In an example with thermal energy storage materials in the thermal battery 140 reaching suitably high temperatures, such as two thousand degrees Fahrenheit (2,000° F.), the thermal energy storage material exchanges heat with a heat transfer fluid (HTF) to raise the temperature of the heat transfer fluid in the heat transfer fluid circuit to approximately seven hundred and fifty (750) to eight hundred and fifty (850) degrees Fahrenheit (° F.). In such examples, the heat transfer fluid in that temperature range is able to generate superheated steam, such as in the heat recovery steam generator 130, with a temperature of at least seven hundred and thirty (730) to eight hundred and thirty (830) degrees Fahrenheit (° F.), or greater, to drive the steam turbine 120. In further examples, operation of the system is able to cause the thermal energy storage material in the thermal battery 140 to reach temperatures chosen based on various design criteria with the heat transfer fluid and generated steam being raised to temperatures that are also chosen based on various criteria.

The auxiliary battery 160 in an example is a battery system that is able to provide fast-response energy for grid stabilization and load demand surges. In an example, the auxiliary battery 160 is able to be a Battery Energy Storage System (BESS) that is installed at any suitable location. The auxiliary battery 160 in an example serves as a supplementary energy storage system that can aid in stabilization of an electrical power grid by providing quick-response electrical energy when it is needed. In the illustrated example, the auxiliary battery 160 exchanges data with the controller 170 via an auxiliary battery communications link 162. In various examples, the controller 170 and auxiliary battery 160 are able to exchange data in one or both direction by any suitable technique.

Controller 170 in an example is a machine learning based, artificial intelligence (AI) powered controller that performs control of various components depicted in the integrated electrical power site schematic 100. The controller 170 in an example receives data from various sources, analyzes that data based on programmed parameters for various purposes such as to forecast energy needs, manage assets, and make decisions to maintain grid stability and efficient energy usage. In the illustrated example, the controller 170 sends control information and receives data from the thermal battery 140 via a thermal battery data link 172, sends control information to the heat transfer fluid pump 144 via heat transfer fluid pump control link 174, sends control information to the steam turbine 120 via a steam turbine control link 176, and sends control information to the combustion turbine 110 via a combustion turbine control link 178.

The power interconnection meter 180 measures parameters of the electrical power generated by the integrated electrical power generation site 102 and provided to the power grid 190 through the power interconnection point 184. The power interconnection meter 180 in an example is able to measure parameters such as an amount of electrical power the integrated electrical power generation site 102 is providing to the power grid 190, various parameters for the electrical power provided to the grid such as reactive power, power factors, other parameters, or combinations of these. The power interconnection meter 180 in an example communicates these measurements to the controller 170 via a power interconnection meter data link 182.

In an example, an external control 186 provides operating parameters to the controller 170 that govern the operation of the integrated electrical power generation site 102. In some examples, the external control 186 sends operating parameters that are specified by an operator of an electrical power grid, such as the power grid 190. In some examples, the external control 186 provides operating parameters such as an amount of electrical power the integrated electrical power generation site 102 is to provide to the power grid 190, various parameters for the electrical power provided to the grid such as reactive power, power factors, other parameters, or combinations of these. In the illustrated example, the external control 186 exchanges information with controller 170 via an external control data link 188. In various examples, the controller 170 and external control 186 are able to exchange data in one or both direction by any suitable technique.

In an example, the controller 170 receives measured electrical power characteristics from the power interconnection meter 180 and compares them to specified characteristics received from the external control 186 or other sources. Based on this comparison, the controller 170 is able to control components of the integrated electrical power generation site 102 to adjust the net electrical power that is provided to the power interconnection point 184 and thus the power grid 190. For example, a determination that the net power delivered to the power grid 190 as measured by the power interconnection meter 180 is less than an amount specified by, for example, the external control 186, the controller 170 is able to command one or more generating elements to increase power output. In an example, the controller 170 is able to increase the speed of the heat transfer fluid pump 144 to increase the amount of heat delivered to the heat recovery steam generator 130 and thus increase the amount of power produced by the steam turbine 120 and thus generator B 122.

In further examples, the controller 170 is able to operate to coordinate other operations by components of the integrated electrical power generation site 102. In an example, the external control 186 or other source sends an indication to the controller 170 to prepare to ramp up the combined cycle electrical power generation plant 104. In such an example, the controller 170 is able to start the heat transfer fluid pump 144 to cause heat in the thermal battery 140 to pre-heat the heat recovery steam generator 130 in preparation for firing up the combustion turbine 110 and initiating full operations of the combined cycle electrical power generation plant 104.

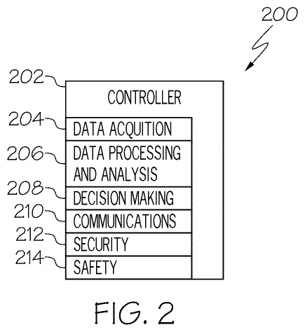

FIG. 2 depicts a controller and program storage 200, according to an example. The controller and program storage 200 is an example of components included in the controller 170 described above. The controller and program storage 200 depicts a controller 202 along with a number of stored programs that consists of an example of processing programs stored for use by a processor within the controller 170 that are used to perform various processes to control the operation of the components of the integrated electrical power generation site 102 described above. In an example, the controller 202 reads and executes the stored programs in order to control the various components and the integrated electrical power generation site 102 and optimize its performance.

The program storage 200 includes a data acquisition sub-system 204. The data acquisition sub-system 204 in an example includes stored programs and data that cause the controller 202 to operate to monitor and collect operational data from various components. In an example, the data acquisition sub-system 204 receives and stores data including one or more of: power output characteristics of the site and individual generators; operational status of various pieces of equipment; errors or faults reported by various pieces of equipment; present configuration or operational settings of various pieces of equipment; readiness state of various pieces of equipment; other data; or any combination of these. The data acquisition sub-system 204 in an example also receives data about the condition of the electrical grid to which the site provides electricity. Such electrical grid conditions include, but are not limited to, overall load, faults, and forecasted demand. In some examples, the data acquisition sub-system 204 is able to receive data in a number of different data formats and transfer data with other processors via a number of various secure data transfer protocols. In some examples, the data acquisition sub-system 204 communicates via data transfer protocols that are tolerant of potential communication interrupts.

The program storage 200 includes a data processing and analysis sub-system 206. The data processing and analysis sub-system 206 in an example includes stored programs and data that cause the controller 202 to operate to process incoming data from various components of the integrated electrical power generation site 102. In an example, the data processing and analysis sub-system 206 processes received data to determine correlations within the data, identify patterns and trends in the data, identify potential faults or issues with equipment within the integrated electrical power generation site 102, perform other processing or analysis, or combinations of these. In an example, the data processing and analysis sub-system 206 includes machine learning based processing, statistical analysis, trend analysis, other processing, or any combination of these, to produce data representing the state of the system and grid, supporting predictions of future conditions, requirements, or combinations of these.

The program storage 200 includes a decision-making sub-system 208. The decision-making sub-system 208 in an example includes stored programs and data that cause the controller 202 to operate to determine settings or adjustments for each component in the integrated electrical power generation site 102 in the response to, for example, current and anticipated grid conditions that are determined based on, for example, outcomes determined by the data processing and analysis sub-system 206. In an example, factors including current and forecasted cloud cover for the photovoltaic array, stored energy in the thermal and auxiliary batteries, temperature and pressure in a heat recovery steam generator such as the above described heat recovery steam generator 130, combustion turbine's current state and readiness for operation, other factors, or combinations of these. In some examples, the decision-making sub-system 208 considers such data in determining settings or adjustments for various components of the integrated electrical power generation site 102.

The program storage 200 includes a communication sub-system 210. The communications sub-system 210 in an example includes stored programs and data that cause the controller 202 to support communications of appropriate control signals or data signals with various components on the integrated electrical power generation site 102, grid operators, other equipment, or combinations of these. These control signals in an example are able to include control signals to adjust the electrical power output level of the solar photovoltaic array 150, routing electricity from the solar photovoltaic array 150 to produce heat to charge the thermal battery 140, preparing the combustion turbine 110 for operation, alerting grid operators of expected changes in power production, other signals, or combinations of these. The communications sub-system 210 in an example is a robust and secure system to ensure reliable, uninterrupted communication with all parts of the system.

The program storage 200 includes security protocols 212. The security protocols 212 in an example include stored programs and data that that cause the controller 202 to operate to define security strategies for software, including but not limited to data encryption, user authentication, operation validation, intrusion detection and prevention methods, other protocols or methods, or any combination of these.

The program storage 200 includes a safety features 214. The safety features 214 in an example include stored programs and data that cause the controller 202 to operate to define safety features performed by the controller 202 to protect the system equipment and ensure the grid's reliability. The safety features 214 in an example include well-defined operational range limits for all components, various failure modes, automatic emergency shutdown procedures, redundant safety controls, or any combination of these.

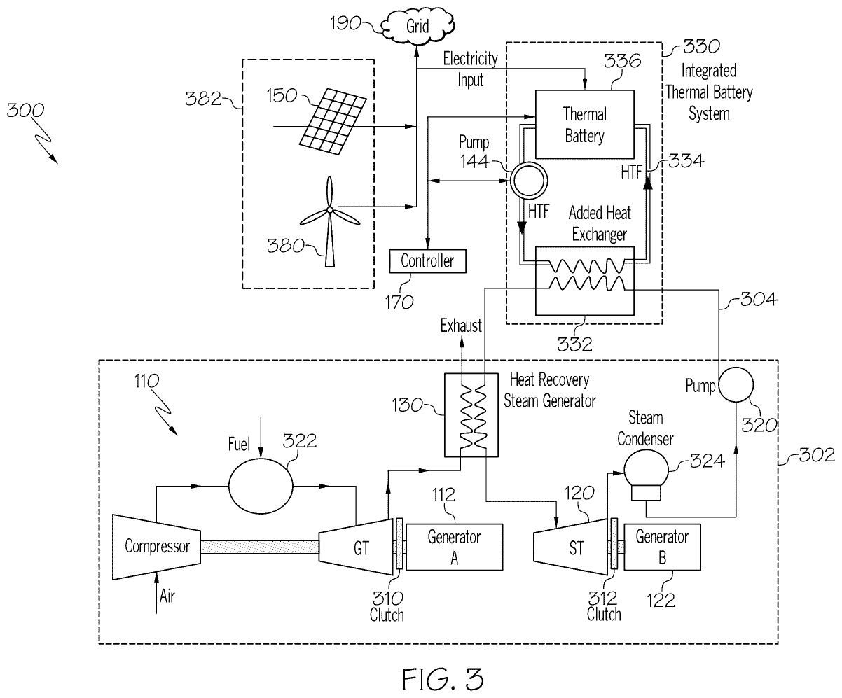

FIG. 3 illustrates a combined cycle plant retrofitting diagram 300, according to an example. The combined cycle plant retrofitting diagram 300 illustrates an example of an existing combined cycle electrical power generating plant 302, which is similar to the above described combined cycle electrical power generation plant 104, to which elements have been added to realize an example integrated electrical power generation site 102. The existing combined cycle electrical power generating plant 302 in this example includes components of the above described integrated electrical power site schematic 100, including the combustion turbine 110 with generator A 112, the steam turbine 120 with generator B 122, and a heat recovery steam generator 130. The existing combined cycle electrical power generating plant 302 further depicts other components including a combustion chamber 322 for the combustion turbine 110, a steam condenser 324 that receives steam from the steam turbine and condenses that steam into a fluid, a steam condenser pump 320 that pumps the condensed steam thorough a steam circuit loop 304.

The combined cycle plant retrofitting diagram 300 depicts that an integrated thermal battery system 330 has been added to the existing combined cycle electrical power generation plant 302 as part of the retrofit depicted the combined cycle plant retrofitting diagram 300. The integrated thermal battery system 330 includes a thermal battery 336, a heat transfer fluid pump 144, a heat transfer fluid loop 334, and an added heat exchanger 332. In the illustrated retrofitted system, the added heat exchanger 332 is added to the steam circuit loop 304 of the existing combined cycle electrical power generation plant 302.

The combined cycle plant retrofitting diagram 300 depicts renewable electrical generation resources 382, such as one or more of the illustrated solar photovoltaic array 150, wind turbine 380, other generators, or combinations of these, that have been added to the existing combined cycle electrical power generation plant 302 as part of the retrofit. In various examples, these renewable electrical generation resources 382 are each an example of a renewable energy electrical power generation plant. These renewable electrical generation resources 382 are connected to and are able to provide electrical power to the power grid 190 and are also able to provide electrical power to the thermal battery 336. In an example, the thermal battery 336 has an electric heater that converts received electrical power to heat for storage. The controller 170 controls the amount of electrical power consumed by the electric heater within the thermal battery 336, and thus the amount of energy generated by the renewable electrical generation resources 382 that is converted into heat that is then stored into the thermal battery 336.

The controller 170 further controls the heat transfer fluid pump 144 that pumps heat transfer fluid through the heat transfer fluid loop 334. The heat transfer fluid being pumped through the heat transfer fluid loop 334 transfers heat stored in the thermal battery 336 to the added heat exchanger 332. The heat delivered to the added heat exchanger 332 is transferred to fluid in the steam circuit loop 304 to create steam to drive the steam turbine 120. In some operating scenarios, heat delivered from the thermal battery 336 to the added heat exchanger 332 is able to be used to pre-heat the heat recovery steam generator 130 in preparation for operation of the combined cycle electrical power generating plant 302.

The illustrated example combined cycle plant retrofitting diagram 300 depicts clutches that have been added to the drive shafts of the generators of the existing combined cycle electrical power generation plant 302. A first clutch 310 has been installed between the combustion turbine 110 and generator A 112, and a second clutch 312 has been installed between the steam turbine 120 and generator B 122. In an example, the first clutch 310 and second clutch 312 have been retrofitted onto the generator drive shafts of the two generators of the existing combined cycle electrical power generation plant 302. In further examples, just one clutch is able to be retrofitted onto the drive shaft of only one of the generators, or a retrofit is able to be performed without adding either clutch. In an example, the first clutch 310 and the second clutch 312 are automatic overrunning clutches, such as are available from the SSS clutch company Inc. of New Castle Delaware, USA. The installation of these clutches allows the existing generators of the existing combined cycle electrical power generation plant 302 to be used as synchronous condensers. In some examples, such clutches are not installed but rather the existing combined cycle electrical power generation plant 302 is modified to allow the generators of the existing combined cycle electrical power generation plant 302 to operate as synchronous condensers while being mechanically coupled to the rotor of their associated turbines in order to increase the inertia of the synchronous condenser.

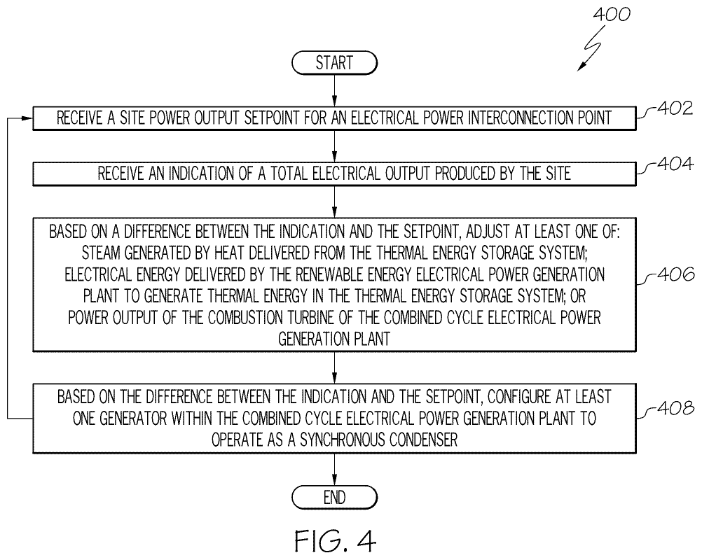

FIG. 4 illustrates an integrated electrical power plant operating process 400, according to an example. The integrated electrical power plant operating process 400 is an example of a process performed by a power adjustment processor. In an example, the power adjustment processor is a processing component that includes components, such as processors, machine executable programs, other components, or combinations of these, that are part of the controller 170 discussed above with regards to the integrated electrical power site schematic 100 to operate the integrated electrical power generation site 102.

The integrated electrical power plant operating process 400 receives, at 402, a site power output setpoint for an electrical power interconnection point. In an example, such as is described above for the integrated electrical power generation site 102, the setpoint is able to be received by any technique. In the above described example of the integrated electrical power generation site 102, such a setpoint is able to be received from the external control 186. In various examples, the received setpoint is able to set one or more of various characteristics for the electrical power to be delivered to the power grid 190 through the power interconnection point 184. Examples of characteristics of the electrical power delivered to the power grid 190 that are able to be specified by the received setpoint include, without limitation, real power, reactive power, power factor, other quantities, or any combination of these.

An indication is received, at 404, of a total electrical output produced by the site. In the example of the above described integrated electrical power generation site 102, such an indication corresponds to measurements made by the power interconnection meter 180 and communicated to the controller 170. In such an example, the indication is received by the controller 170 from the power interconnection meter 180 via the power interconnection meter data link 182.

The received indication in various examples is able to include any measured quantity of the electrical power that is delivered through the power interconnection point 184 to the power grid 190. Such indications are able to indicate, for example and without limitation, real power, reactive power, power factor, other quantities, or any combination of these.

The integrated electrical power plant operating process 400 operates by, based on a difference between the indication and the setpoint, adjusting, at 406, at least one of: steam generated by heat delivered from the thermal energy storage system; electrical energy delivered by the renewable energy electrical power generation plant to generate thermal energy in the thermal energy storage system; or power output of the combustion turbine of the combined cycle electrical power generation plant. In an example, such adjusting is performed to reduce a difference between the indication and the setpoint in order to maintain the electrical power delivered to the power grid 190 within parameters defined by the setpoint.

The integrated electrical power plant operating process 400 in an example operates by, based on the difference between the indication and the setpoint, configuring, at 408, at least one generator within the combined cycle electrical power generation plant to operate as a synchronous condenser. In an example, the controller 170 is able to receive a setpoint that specifies that a relatively large amount of negative (capacitive) reactive power is to be provided to the power grid 190. In such an example, the controller 170 configures the operating conditions of one or both of generator A 112 and/or generator B 122 to operate as synchronous condensers.

Operation of one or both of these generators as a synchronous condenser is able to be achieved by one or more of several techniques. For example, a combustion or steam turbine attached to the generator is able to bring that generator up to operating speed while properly exciting the rotor of the generator so that connection of the generator to the power interconnection 184 results in proper operation of the generator as a synchronous condenser. In some examples, the one or more generators are able to have a clutch, such as the first clutch 310 or the second clutch 312 described above, to allow the generator to “freewheel,” either automatically or through control by, for example, controller 170, while operating as a synchronous condenser. In further examples, the generators are able to maintain a fixed connection to the turbine rotor to which they are attached. Such couplings that provide connections, disconnections, or combinations of these between the generator and its turbine are able to be achieved by any suitable design.

The integrated electrical power plant operating process 400 returns to receiving, at 402, a site power output setpoint for an electrical power interconnection point.

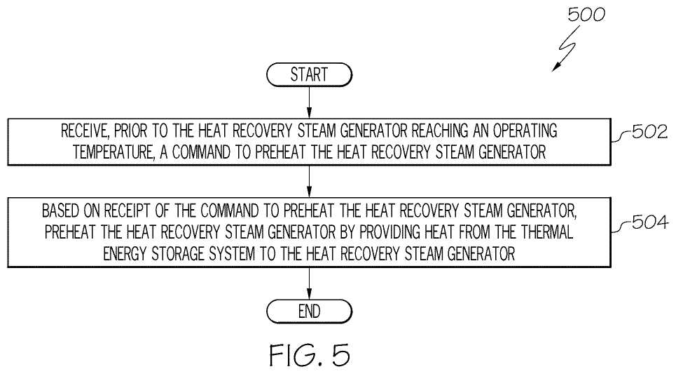

FIG. 5 illustrates a heat recovery steam generator preheating process 500, according to an example. The heat recovery steam generator preheating process 500 is an example of a process controlled by the controller 170 to preheat the heat recovery steam generator 130. In an example, start-up operations of the combined cycle electrical power generation plant 104 includes preheating of the heat recovery steam generator 130 so as to allow proper exchange of excess heat from the combustion turbine 110 to the steam loop of the steam turbine 120. Such preheating in a conventional combined cycle electrical power generation plant 104 may involve a lengthy run up period for the combustion turbine 110. In an example, the heat recovery steam generator preheating process 500 uses heat stored in the thermal battery 140 to preheat the heat recovery steam generator 130 in preparation for full operation of the combined cycle electrical power generation plant 104. Such preheating allows a more rapid and energy efficient initiation of operation of the combined cycle electrical power generation plant 104.

The heat recovery steam generator preheating process 500 receives, at 502, prior to the heat recovery steam generator reaching an operating temperature, a command to preheat the heat recovery steam generator. Such a command is able to be received from any source, such as the external control 186.

Based on receipt of the command to preheat the heat recovery steam generator, the heat recovery steam generator is preheated, at 504, by providing heat from the thermal energy storage system to the heat recovery steam generator. In an example such as is depicted by the integrated electrical power site schematic 100, such heat is provided by the controller 170 activating heat transfer fluid pump 144 to pump heat transfer fluid and thus convey heat from the thermal battery 140 to the heat recovery steam generator 130. In an example such as depicted for the combined cycle plant retrofitting diagram 300, the controller 170 activates heat transfer fluid pump 144 to transfer heat to the added heat exchanger 332 and also activates pump 320 to transfer heat to the heat recovery steam generator 130. The heat recovery steam generator preheating process 500 then ends.

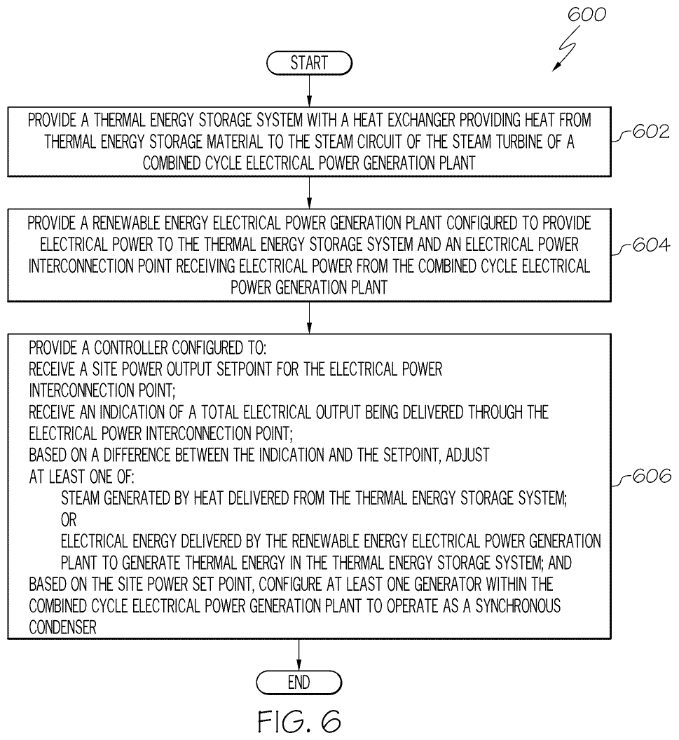

FIG. 6 illustrates a combined cycle electrical power generation plant retrofitting process 600, according to an example. The combined cycle electrical power generation plant retrofitting process 600 is an example of a process to retrofit an existing combined cycle electrical power generation plant to include components to create an example of an integrated electrical power plant as is described above.

The combined cycle electrical power generation plant retrofitting process 600 provides, at 602, a thermal energy storage system with a heat exchanger providing heat from thermal energy storage material to the steam circuit of the steam turbine of the combined cycle electrical power generation plant. The above described integrated thermal battery system 330 is an example of such a thermal energy storage system. In an example as is described above with regards to the combined cycle plant retrofitting diagram 300, this thermal energy storage system is added to the existing combined cycle electrical power generating plant 302.

A renewable energy electrical power generation plant is provided, at 604. The renewable energy electrical power generation plant in an example is configured to provide electrical power to 1) the thermal energy storage system; and 2) an electrical power interconnection point receiving electrical power from the combined cycle electrical power generation plant. Examples of a renewable energy electrical power generation plant include the above described solar photovoltaic array 150, any solar based electrical generation system, wind turbines 380, other renewable energy electrical power generation systems, or combinations of these.

A controller is provided, at 606. The controller in an example is configured to: 1) receive a site power output setpoint for the electrical power interconnection point; 2) receive an indication of a total electrical output being delivered through the electrical power interconnection point; 3) based on a difference between the indication and the setpoint, adjust at least one of: a) steam generated by heat delivered from the thermal energy storage system; or b) electrical energy delivered by the renewable energy electrical power generation plant to generate thermal energy in the thermal energy storage system; and 4) based on the site power output setpoint, configure at least one generator within the combined cycle electrical power generation plant to operate as a synchronous condenser.

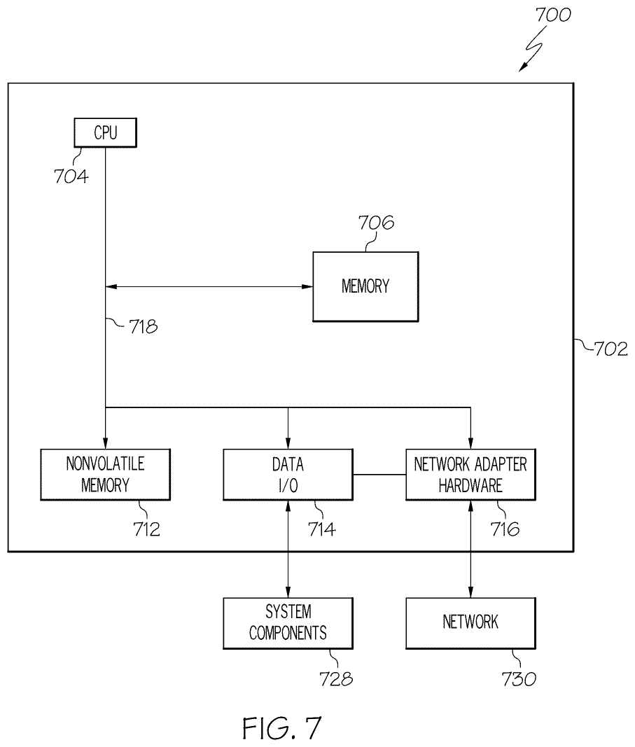

FIG. 7 illustrates a block diagram illustrating a controller system 700 according to an example. The controller system 700 is an example of a processing subsystem that is able to perform any of the above described processing operations, control operations, other operations, or combinations of these.

The controller system 700 in this example includes a processing subsystem 702 that includes a CPU 704 that is communicatively connected to a main memory 706 (e.g., volatile memory), a non-volatile memory 712 to support processing operations. The processing subsystem includes network adapter hardware 716 to support input and output communications between the CPU 704 and external computing systems such as through the illustrated network 730.

The processing subsystem 702 further includes a data input/output (I/O) processor 714 that is able to be adapted to communicatively couple the CPU 704 with any type of equipment, such as the illustrated system components 728. The data input/output (I/O) processor 714 in various examples is able to be configured to support any type of data communications connections including present day analog and/or digital techniques or via a future communications mechanism. A system bus 718 interconnects these system components.

### Information Processing System

The present subject matter can be realized in hardware, software, or a combination of hardware and software. A system can be realized in a centralized fashion in one computer system, or in a distributed fashion where different elements are spread across several interconnected computer systems. Any kind of computer system-or other apparatus adapted for carrying out the methods described herein—is suitable. A typical combination of hardware and software could be a general purpose computer system with a computer program that, when being loaded and executed, controls the computer system such that it carries out the methods described herein.

The present subject matter can also be embedded in a computer program product, which comprises all the features enabling the implementation of the methods described herein, and which—when loaded in a computer system-is able to carry out these methods. Computer program in the present context means any expression, in any language, code or notation, of a set of instructions intended to cause a system having an information processing capability to perform a particular function either directly or after either or both of the following a) conversion to another language, code or, notation; and b) reproduction in a different material form.

Each computer system may include, inter alia, one or more computers and at least a computer readable medium allowing a computer to read data, instructions, messages or message packets, and other computer readable information from the computer readable medium. The computer readable medium may include computer readable storage medium embodying non-volatile memory, such as read-only memory (ROM), flash memory, disk drive memory, CD-ROM, and other permanent storage. In general, the computer readable medium embodies a computer program product as a computer readable storage medium that embodies computer readable program code with instructions to control a machine to perform the above described methods and realize the above described systems.

### Non-Limiting Examples

Although specific embodiments of the subject matter have been disclosed, those having ordinary skill in the art will understand that changes can be made to the specific embodiments without departing from the spirit and scope of the disclosed subject matter. The scope of the disclosure is not to be restricted, therefore, to the specific embodiments, and it is intended that the appended claims cover any and all such applications, modifications, and embodiments within the scope of the present disclosure.

What is claimed is:

1. A method of operating an integrated electrical power plant, the method comprising:
receiving a site power output setpoint for an electrical power interconnection point that receives power from a combined cycle electrical power generation plant and a renewable energy electrical power generation plant, and wherein a thermal energy storage system is configured to provide heat to generate steam to drive a steam turbine of the combined cycle electrical power generation plant;
receiving an indication of a total electrical output delivered to the electrical power interconnection point;
based on a difference between the indication and the site power output setpoint, adjusting at least one of:
the steam generated by the heat delivered from the thermal energy storage system; or
electrical energy delivered by the renewable energy electrical power generation plant to generate thermal energy in the thermal energy storage system.

2. The method of claim 1, wherein the thermal energy storage system contains thermal energy storage material that reaches temperatures of at least as two thousand degrees Fahrenheit (2,000° F.).

3. The method of claim 1, wherein the thermal energy storage system provides the heat to generate the steam as superheated steam to drive the steam turbine, where the superheated steam is greater than seven hundred and thirty (730) degrees Fahrenheit.

4. The method of claim 1, wherein the thermal energy storage system is further configured to provide the heat to a heat recovery steam generator within the combined cycle electrical power generation plant, and wherein the method further comprises:
receiving, prior to the heat recovery steam generator reaching an operating temperature, a command to preheat the heat recovery steam generator; and
based on receiving the command to preheat the heat recovery steam generator, preheating the heat recovery steam generator by providing the heat from the thermal energy storage system to the heat recovery steam generator.

5. The method of claim 1, wherein the thermal energy storage system comprises:
thermal energy storage material;
a heat exchanger to provide the heat to a steam circuit driving the steam turbine; and
a heat transfer fluid exchanging the heat between the thermal energy storage material and the heat exchanger.

6. The method of claim 1, wherein the adjusting further comprises adjusting, based on the difference between the indication and the site power output setpoint, a power output of a combustion turbine of the combined cycle electrical power generation plant.

7. The method of claim 1, further comprising, based on the site power output setpoint, configuring at least one generator within the combined cycle electrical power generation plant to operate as a synchronous condenser.

8. The method of claim 1, further comprising, based on the site power output setpoint, configuring at least one generator within the combined cycle electrical power generation plant to operate as a synchronous condenser while the at least one generator is mechanically linked to and turning a rotor of a turbine.

9. An integrated electrical power plant, comprising:
an electrical power interconnection point;
a combined cycle electrical power generation plant configured to provide first electrical power to the electrical power interconnection point;
a renewable energy electrical power generation plant configured to provide second electrical power to the electrical power interconnection point;
a thermal energy storage system is configured to provide heat to generate steam to drive a steam turbine of the combined cycle electrical power generation plant;
a processor, communicatively coupled to the combined cycle electrical power generation plant, the renewable energy electrical power generation plant, and the thermal energy storage system;
a memory, communicatively coupled to the processor; and
a power adjustment processor, communicatively connected to the processor and the memory, configured to, when operating:
receive a site power output setpoint for an electrical power interconnection point;
receive an indication of a total electrical output delivered to the electrical power interconnection point; and
based on a difference between the indication and the site power output setpoint, adjust at least one of:
the steam generated by the heat delivered from the thermal energy storage system; or
electrical energy delivered by the renewable energy electrical power generation plant to generate thermal energy in the thermal energy storage system.

10. The integrated electrical power plant of claim 9, wherein the thermal energy storage system contains thermal energy storage material that, when operating, reaches temperatures of at least as two thousand degrees Fahrenheit (2,000° F.).

11. The integrated electrical power plant of claim 9, wherein the thermal energy storage system provides the heat to generate the steam as superheated steam to drive the steam turbine, where the superheated steam is greater than seven hundred and thirty (730) degrees Fahrenheit.

12. The integrated electrical power plant of claim 9, wherein the thermal energy storage system is further configured to provide the heat to a heat recovery steam generator within the combined cycle electrical power generation plant, and wherein the power adjustment processor is further configured to, when operating:
receive, prior to the heat recovery steam generator reaching an operating temperature, a command to preheat the heat recovery steam generator; and
based on receiving the command to preheat the heat recovery steam generator, preheat the heat recovery steam generator by providing the heat from the thermal energy storage system to the heat recovery steam generator.

13. The integrated electrical power plant of claim 9, wherein the thermal energy storage system comprises:
thermal energy storage material;
a heat exchanger to provide the heat to a steam circuit driving the steam turbine; and
a heat transfer fluid exchanging the heat between the thermal energy storage material and the heat exchanger.

14. The integrated electrical power plant of claim 9, wherein the power adjustment processor is further configured to, when operating, adjust, based on a difference between the indication and the site power output setpoint, a power output of a combustion turbine of the combined cycle electrical power generation plant.

15. The integrated electrical power plant of claim 9, wherein the power adjustment processor is further configured to, when operating, based on the site power output setpoint, configure at least one generator within the combined cycle electrical power generation plant to operate as a synchronous condenser.

16. The integrated electrical power plant of claim 9, wherein the power adjustment processor is configured to, when operating, based on the site power output setpoint, configure at least one generator within the combined cycle electrical power generation plant to operate as a synchronous condenser by at least operating the at least one generator as the synchronous condenser while the at least one generator is mechanically linked to and turning a rotor of a turbine.

17. A method of retrofitting a combined cycle electrical power generation plant, the method comprising:
providing a thermal energy storage system with a heat exchanger providing heat from thermal energy storage material to steam within a steam circuit of a steam turbine of the combined cycle electrical power generation plant;
providing a renewable energy electrical power generation plant configured to provide electrical power to:
the thermal energy storage system configured to store energy received in electrical power as thermal energy in the thermal energy storage material; and
an electrical power interconnection point receiving electrical power from the combined cycle electrical power generation plant;
providing a controller configured to:
receive a site power output setpoint for the electrical power interconnection point;
receive an indication of a total electrical output through the electrical power interconnection point; and
based on a difference between the indication and the site power output setpoint, adjust at least one of:
the steam generated by the heat delivered from the thermal energy storage system; or
electrical energy delivered by the renewable energy electrical power generation plant to generate thermal energy in the thermal energy storage system.

18. The method of claim 17, further comprising:
providing a respective mechanical disconnect between at least one turbine in the combined cycle electrical power generation plant and an associated generator, and
wherein the controller is further configured to, based on the site power output setpoint, configure at least one generator within the combined cycle electrical power generation plant to operate as a synchronous condenser.

19. The method of claim 17, wherein the thermal energy storage system is further configured to provide the heat to a heat recovery steam generator within the combined cycle electrical power generation plant, and wherein the controller is further configured to, when operating:
receive, prior to the heat recovery steam generator reaching an operating temperature, a command to preheat the heat recovery steam generator; and
based on receiving the command to preheat the heat recovery steam generator, preheat the heat recovery steam generator by providing the heat from the thermal energy storage system to the heat recovery steam generator.

20. The method of claim 17, wherein the controller is configured to, when operating, based on the site power output setpoint, configure at least one generator within the combined cycle electrical power generation plant to operate as a synchronous condenser by at least operating the at least one generator as the synchronous condenser while the at least one generator is mechanically linked to and turning a rotor of a turbine.
